(19) United States
(12) Patent Application Publication
(10) Pub. No.: US 2018/0197145 A1
(43) Pub. Date: Jul. 12, 2018

(54) MULTI-STAGE SERVICE RECORD COLLECTION AND ACCESS

(71) Applicants: Gavin LaRowe, Spokane, WA (US); Michael Cabacungan, SR., Port Orchard, WA (US)

(72) Inventors: Gavin LaRowe, Spokane, WA (US); Michael Cabacungan, SR., Port Orchard, WA (US)

(21) Appl. No.: 15/400,915

(22) Filed: Jan. 6, 2017

(51) Int. Cl. G06Q 10/10; G06F 17/30; G06F 21/62

(52) U.S. Cl. CPC G06Q 10/105; G06Q 50/26; G06F 21/6245; G06F 17/30312

(57) ABSTRACT

A third-party operated service record engine may provide government agencies with a centralized location to retain the service records of their government employees. Service record data for career stages of a government employee from data sources of the government agency for storage at the third-party service provider. The service record data may be collected under an agency data collection rule specific to the government agency. The service record data are stored in a service record database maintained by the third-party service provider for the government agency. Access to a portion of the service record data is provided according to an agency data access rule. The agency data access rule being configured for the government agency by the third-party service provider based at least on laws and regulations of the jurisdiction in which the government agency resides.

### BACKGROUND

Communities count on their local or regional government personnel to provide governmental and public services. Some of the government personnel may include emergency services employees, such as law enforcement officers, firefighters, and emergency medical technicians, that respond to emergencies and crisis situations. Government personnel generally undergo strict background checks before they are able to work in government services. Further, specialized government personnel such as emergency services employees also undergo rigorous training in order to prepare for their roles as first responders. Furthermore, due to their vital roles in protecting and serving the public, some government personnel are expected to meet ongoing standards, such as ethical standards, educational standards, professional development standards, physical ability standards, and/or so forth, during their service careers. Since most emergency services employees are also public servants, such employees may also receive publicly funded retirement or disability benefits at the end of their careers. Accordingly, government agencies that employ government employees have strong incentives to keep accurate service records that document career developments and activities affecting the ability of the government employees to fulfill their duties.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture for collecting and providing access to service record data for multiple career stages of a government employee based on agency data collection and data access rules.

FIG. 2 is a block diagram showing various components of one or more computing nodes that implement a service record engine for collecting and providing access to service record data for multiple career stages of government employee based on agency data collection and data access rules.

FIG. 3 is a flow diagram of an example process for retrieving service record data for multiple career stages of a government employee, in which the service record data is collected based on multiple versions of an agency data collection rule.

FIG. 4 is a flow diagram of an example process for obtaining a missing data portion in the service record of a government employee from a third-party source.

FIG. 5 is a flow diagram of an example process for overcoming an agency data access rule to provide access to a previously inaccessible data portion in the service record of a government employee.

FIG. 6 is a flow diagram of an example process for periodically updating an agency rule that governs data collection or data access with respect to the service records of government employees.

FIG. 7 is a flow diagram of an example process for receiving data regarding the service record of a government employee from multiple data sources.

### DETAILED DESCRIPTION

This disclosure is directed to techniques for using a service record engine to control the collection and access to the service records of government employees. The government employees may include any person that is employed or retained by a government agency to perform tasks or services for the government agency in exchange for compensation. A government agency may be established by any number of government units, such as a local government unit, a state government unit, a federal government unit, and/or so forth. For example, the government employees may include emergency services employees (e.g., law enforcement officers, firefighters, emergency medical technicians, etc.), administration employees, financial and accounting department employees, human resources employees, information technology employees, community program employees, and/or so forth. Data for the service record of a government employee may be collected from multiple data sources based on an agency data collection rule. The agency data collection rule for the government agency may be configured based on the agency data collection polices of the agency. The multiple data sources for the service record may provide data that correspond to different career stages of the government employee. For example, the different career stages of a government employee may include a recruitment stage, a training stage, one or more career level stages, and a retirement stage.

The service record data obtained from each data source for a government employee may include any data that may affect the ability of the government employee to perform duties for the government agency. For example, the data may include background check information, training and certification information, career promotion information, award and commendation information, disciplinary action information, health and fitness information, retirement-related information, and/or so forth. In at least some embodiments, the service record engine may be operated by a third-party service provider that is contracted with the government agency to provide centralized service record retention and access services.

The service record engine may also provide access to the service record of the government employee according to an agency data access rule of the government agency. The agency data access rule may dictate the type and/or nature of the data in the service record of the government employee that can be access by an authorized user. The agency data access rule may be configured by the third-party service provider for the government agency based on federal, state, local, and/or agency laws and regulations regarding individual privacy, confidential information, government classified data, and/or so forth. In various embodiments, the authorized user may be the government employee, a supervisor of the employee, a manager of the government agency, an auditor of the government agency, a system administrator of the service record engine, and/or so forth. Accordingly, the agency data access rule may dictate that different types of authorized parties may be provided with varied or limited access to the service record of a government employee. In some instances, the service record engine may be capable of using machine learning to analyze the service records of multiple government employees to generate statistics, trends, or patterns indicating issues that affect the employees.

Since the service record engine collects and stores service record data for government employees of a government agency based on a corresponding agency data collection rule, the government agency may be assured that the collection of service record data for its government employees complies with applicable jurisdictional laws and regulations. Additionally, since the service record engine provides access to the service records of the government employees according to a corresponding agency data access rule, the government agency may be assured that any disclosure of service record information to authorized internal parties and third parties adhere to the applicable jurisdictional laws and regulations.

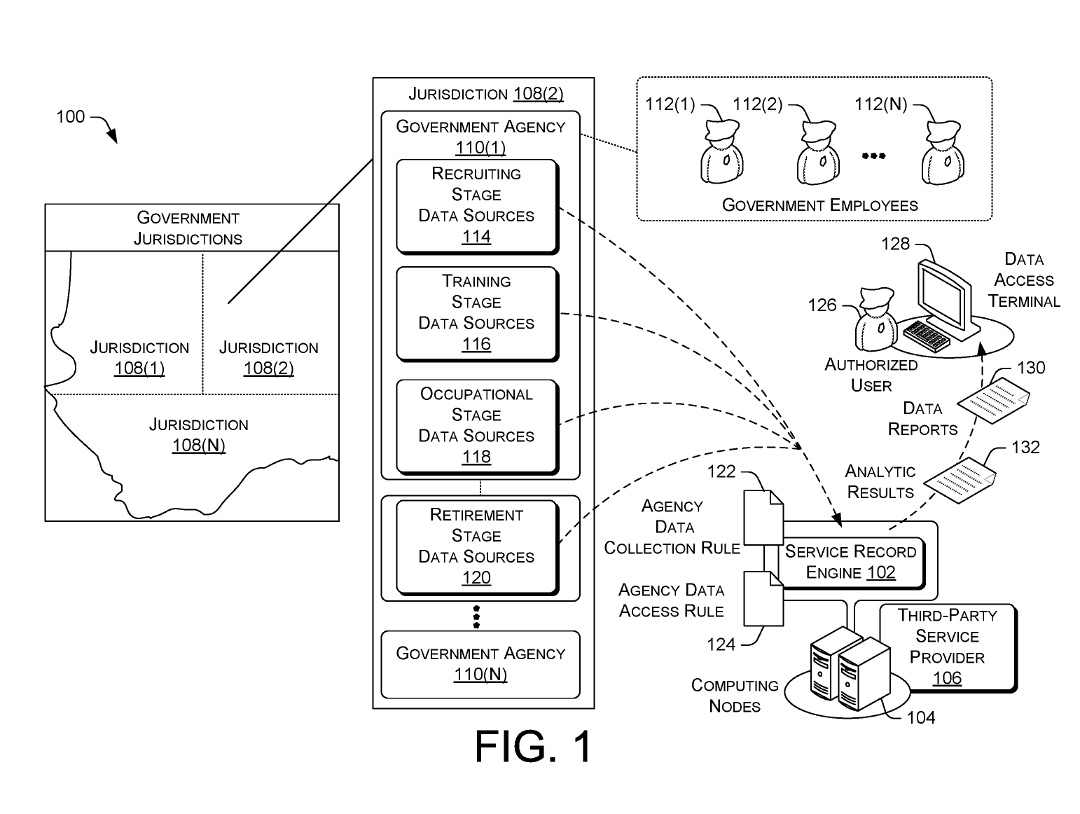

A third-party operated service record engine may provide government agencies with a centralized location to retain the service records of their government employees without having to invest in and maintain their own information technology infrastructure. The service record engine may also provide the government agencies or the operator of the service record engine with the ability to analyze the service records to ascertain systematic problems and trends that may affect the careers and lives of their government employees. Accordingly, the use of the service record engine by government agencies may result in reduced operating cost and greater convenience for the agencies. The techniques described herein may be implemented in a number of ways. Example implementations are provided below with reference to the following FIGS. 1-7.

### Example Architecture

FIG. 1 illustrates an example architecture for collecting and providing access to service record data for multiple career stages of a government employee based on agency data collection and data access rules. The architecture 100 may include a service record engine 102 that executes on one or more computing nodes 104. The computing nodes 104 may be distributed processing nodes that are scalable according to workload demand. In various embodiments, the computing nodes 104 may include general purpose computers, such as desktop computers, tablet computers, laptop computers, servers, and so forth. However, in other embodiments, the computing nodes 104 may be in the form of virtual machines, such as virtual engines (VE) and virtual private servers (VPS). The computing nodes 104 may store data in a distributed storage system, in which data may be stored for long periods of time and replicated to guarantee reliability. Accordingly, the computing nodes 104 may provide data storage and processing redundancy, in which data processing and data storage may be scaled up or down in response to demand. Further, new computing nodes 104 may be added on the fly without affecting the operational integrity of the service record engine 102.

The service record engine 102 may collect service record data of government employees of government agencies that are in different government jurisdictions. The service record engine 102 may be operated by a third-party service provider 106. Accordingly, the third-party service provider 106 may collect such data from a government agency after obtaining consent from the government agency and/or employees of the government agency. In various embodiments, the third-party service provider 106 may be a private enterprise that contracts with government agencies to provide data retention and data access services. The jurisdictions may include the jurisdictions 108(1)-108(N), in which each of the jurisdictions may cover separate or overlapping geographical areas. Each of the jurisdictions may have its own set of laws and regulations governing data collection and data access for employee service records that are applicable to the government agencies in the jurisdiction. Alternatively or concurrently, the jurisdictions may share common laws and regulations that are applicable to their government agencies. Such laws and regulations of a jurisdiction may be enacted by one or more governing bodies that have legal authority over the jurisdiction, and/or by the government agencies themselves under the legal mandates of the one or more governing bodies. In some instances, a jurisdiction may be served by one or more government agencies. The government agencies may include federal, state, or local agencies, as well as agencies that are affiliated with international intergovernmental organizations. Further, the government agency may provide various public services, such as law enforcement, medical aid, firefighting, disaster relief, public works, and/or so forth.

In the example shown in FIG. 1, the jurisdiction 108(2) may be served by multiple government agencies, such as the government agency 110(1)-110(N). The service records of the government employees for each of the government agencies may be obtained from one or more data sources. Each of data sources may be maintained by a corresponding government agency, or by a third-party for access by the corresponding government agency. For example, the service records for the government employees 112(1)-112(N) of the government agency 110(1) may be obtained from recruiting stage data sources 114, training stage data sources 116, occupational stage data sources 118, and retirement stage data sources 120. Each of the data sources may be a data archive or database that contains data in electronic form and/or in printed form. Thus, in instances in which the data is electronic data stored in an electronic database, the electronic data may be imported into the service record engine 102. However, in instances in which the data is in printed form, the data may be digitized via scanning or other imaging technology into electronic form prior to importation into the service record engine 102.

The recruiting stage data sources 114 may provide data such as personal identification information, demographic information, educational attainment information, background check information, aptitude test score information, and/or so forth for a government employee. The background check information may include criminal background check reports, credit worthiness reports, court adjudication reports, physical and mental health reports, and/or any other report that are relevant to the ability of the employee to perform the service role of the employee. The training stage data sources 116 may provide data on the status of the government employee in completing related training or certification programs. For example, in the context of a law enforcement officer, the training or certification may be the successful completion of police academy training. In the context of an emergency medical technician, the training or certification may be the successful completion of an emergency medical technician program. Accordingly, the successful completion of a certification or training program by a government employee may indicate that the employee has attained basic proficiency in performing corresponding service related duties.

The occupational stage data sources 118 may provide data on the service history and achievements of a government employee. The service history information of the government employees may be divided and stored in different data sources based on the seniority levels achieved by the employee. For example, in the context of a law enforcement officer, the different seniority levels may include Officer, Detective, Sergeant, Lieutenant, Captain, Assistant Chief, Chief, etc. In the context of a firefighter, the different seniority levels may include Firefighter, Engineer, Lieutenant, Captain, Battalion Chief, and Commissioner, etc. The service history may include performance evaluation reports, continued training and education certification, duty incident logs, achievement logs, commendation reports, disciplinary action reports, and/or so forth. The duty incident log may include information on accidents, injuries, medical issues, use of force events, legal actions, or other non-ordinary events that occurred during the service of the government employee. The occupational stage data sources 118 may include both internal data sources as well as third-party data sources. For example, a third-party data source may be a database that is maintained by an employee union or guild that tracks disputes between the employee and the government agency that is settled by the union or guild. In such instances, the service record engine 102 may collect information from such a third-party data source after the third-party service provider 106 has obtained the consent of the third-party and/or the government employee who is associated with the third-party.

The retirement stage data sources 120 may provide post-career data on a government employee. The post-career data may include pension plan status, medical benefit status, health condition status, and/or other data that measure the effect of a career in government has on the quality of life for the government employee. The retirement stage data sources 120 may include both internal data sources as well as third-party data sources. For example, a third-party data source may be a database that is maintained by an employee retirement guild or a public health institution. Accordingly, the service record engine 102 may collect information from such a third-party data source after the third-party service provider 106 has obtained the consent of the third-party and/or the government employee who is associated with the third-party. Other examples of third-party data sources for different career stages may include data sources of credit card reporting agencies, health care facilities, government judicial bodies, and/or so forth.

The service record engine 102 may collect the service record data for each government employee of a government agency according to a corresponding agency data collection rule, such as the agency data collection rule 122. The agency data collection rule for a government agency may be configured based on the agency data collection polices of the agency. In turn, the agencies data collection policies may be crafted by the agency based on federal, state, local laws and regulations of the jurisdiction in which the government agency resides, practices of the agency, and/or so forth. For example, an applicable state regulation may prohibit the collection of certain health information on government employees in the jurisdiction. In another example, an applicable government agency policy may mandate the collection of educational background information from its government employee. Accordingly, such data collection parameters that affect a government agency may be coded by the service record engine 102 into an agency data collection rule for the agency. However, as the laws, regulations, and/or agency policies change over time, the service record data collected by the service record engine 102 for an agency may change as well.

The service record engine 102 may provide access to the service record data of each government employee of a government agency according to a corresponding agency data access rule, such as the agency data access rules 124. The agency data access rule may be configured based on federal, state, and/or local laws and regulations of the jurisdiction in which the government agency resides. For example, an applicable federal rule may prohibit the release of health information on a government employee in the jurisdiction without the consent of the employee. In another example, an applicable government agency policy may prohibit the collection of certain personal information of its government employee to unauthorized individuals to protect the employee's privacy. Accordingly, such data access parameters that affect a government agency may be coded by the service record engine 102 into agency data access rules for the agency. Thus, when a particular portion of service record data is requested by an authorized individual, the service record engine 102 may automatically use the agency data access rules to determine whether the portion of data may be released to the authorized individual.

An authorized user 126 may access the service record data of government employees of a government agency, such as the government agency 110(1), via a data access terminal 128. In various embodiments, the authorized user 126 may be a government employee, a supervisor of the employee, a manager of the government agency, an auditor of the government agency, a system administrator of the service record engine 102. The data access terminal 128 may be located at the government agency 110(1) or at a remote location. The data access terminal 128 may interface with the computing nodes 104 via a network. The network may be a local area network (LAN), a larger network such as a wide area network (WAN), or a collection of networks, such as the Internet.

The data access terminal 128 may provide user interfaces that enable the authorized user 126 to input queries for specific service record data of one or more government employees. The input queries may include one or more specific query parameters for retrieving data that is particular to one or more employees, one or more professional milestones, circumstances, events, injuries, achievements, duty incidents, and/or so forth. In turn, the service record engine 102 may retrieve matching data based on the query parameters to generate data reports 130, in which the data presented in the data reports may be subject to the corresponding agency data access rules.

The service record engine 102 may further perform data analysis on the service records of government employees to generate analytic results 132. The data analysis may be performed specifically with respect to the government employees of a government agency, or the employees of multiple government agencies that have consented to the data analysis. The data analysis may be performed using machine learning algorithms to detect correlation or causation trends in the careers of the government employees. For example, the analysis may be used to discover common injury patterns, common medical issues, correlation between education level attained to promotion level attained, correlation between number of hours of a shift and injury, and/or so forth. In some instances, the data analysis may be performed using a combination of service records data and third-party data. The third-party data may include social media data, agency public disclosure data, proprietary data of other service providers, and/or so forth.

### Example Computing Node Components

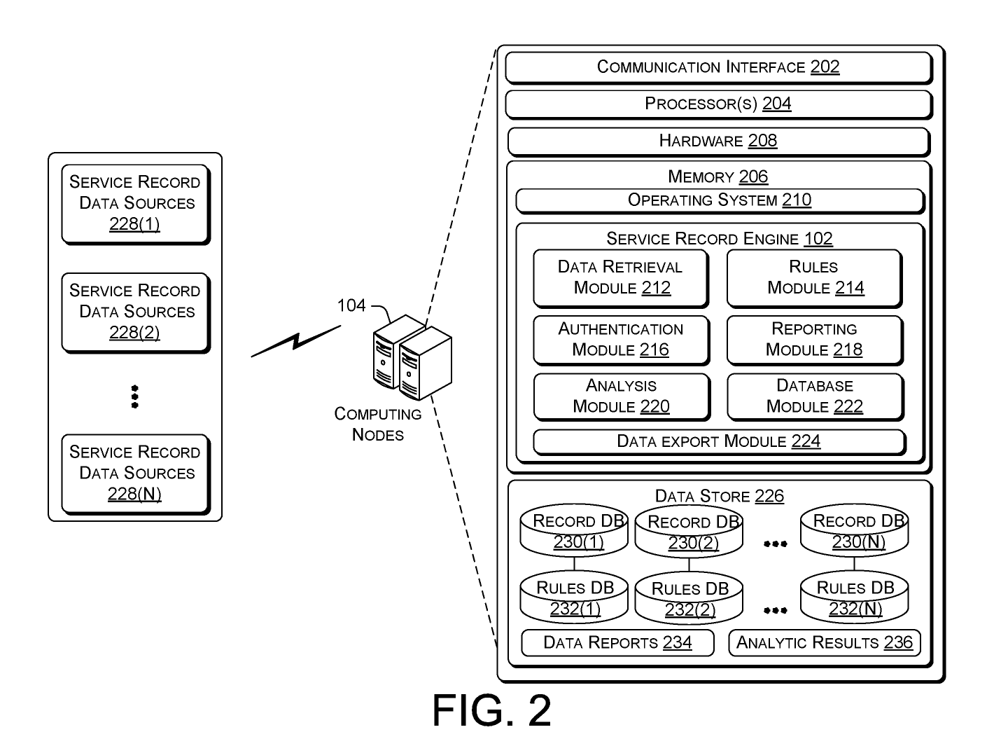

FIG. 2 is a block diagram showing various components of one or more computing nodes 104 that implement a service record engine for collecting and providing access to service record data for multiple career stages of a government employee based on agency data collection and data access rules.

The computing nodes 104 may include a communication interface 202, one or more processors 204, and memory 206. The communication interface 202 may include wireless and/or wired communication components that enable the one or more computing nodes 104 to transmit data to and receive data from other networked devices. The computing nodes 104 may be accessed via hardware 208. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The computing nodes 104 may be used to implement the service record engine 102. The service record engine 102 may include a data retrieval module 212, a rules module 214, an authentication module 216, a reporting module 218, an analysis module 220, a database module 222, and a data export module 224. The modules may include routines, program instructions, objects, and/or data structures that perform particular tasks or implement particular abstract data types. The computing nodes may further host a data store 226.

The data retrieval module 212 may receive service record data from agency data sources of government agencies, such as service record data sources 228(1)-228(N). For example, the agency data sources 228(1)-228(N) may include the data sources 114-120 of the government agency 110(1). The data retrieval module 212 may store the service record data received from the data sources of government agencies in respective record databases 230(1)-230(N). In instances in which a service record data source contains non-electronic data, an operator of the service record engine 102 may manually input the service record data into a record database via an application user interface. The application user interface may be generated by the data retrieval module 212 for presentation via a standalone application or a web browser executing on a computing device. Alternatively, the operator may convert the non-electronic data into electronic data via scanning or imaging tools for input into the data retrieval module 212. However, in instances in which a service record data source is an electronic database that contains electronic data, the data retrieval module 212 may be configured to receive the data using data adapters. For example, when the database is a proprietary database, the data retrieval module 212 may use a proprietary data adapter to access the data in the proprietary database. Subsequently, the data retrieval module 212 may use a data converter to convert the data received from the proprietary database into a generic format for storage in a records database. However, if the database is a structured database, the data retrieval module 212 may use a data-agnostic data adapter to access the structured database and obtain the data. The data-agnostic data adapter may retrieve the data from the structured database without regard to the specific content or format of the data the structured database.

The data retrieval module 212 may use a filtering mechanism to ensure that the storage of the service record data collected from a government agency conforms to a corresponding agency data collection rule. The filtering mechanism may employ a data recognition algorithm to automatically detect data that have certain data format, contain certain alphanumeric text, words, or phrases, tagged as being from certain sources. Accordingly, the data retrieval module 212 may generate alerts via an application user interface to indicate either service record data that is missing from a data source which should be obtained, or service record data that is no longer collectible from a data source, under a new version of the agency data collection rule for the agency. In a scenario in which the service record data is no longer collectible, the data retrieval module 212 may automatically discard the data obtained from a data source.

The rules module 214 may generate an agency data collection rule for a government agency based on an agency data collection policy. Aspects of an agency data collection policy that is in printed form may be manually inputted into the rules module 214 via an application user interface provided by the rules module 214. In various embodiments, the application user interface may display multiple classes of service record data and options for customize the data collection configuration with respect to each category. The application user interface may further enable a user to create additional classes and define the data collection configuration for each newly defined class.

However, aspects of an agency data collection policy that is in electronic form may be automatically parsed using a data analysis algorithm, such as a machine learning engine and/or a textual analysis engine. The data analysis algorithm may search for different classes of service record data that are present in the data collection policy to generate a set of data collection configurations for the different classes of service record data. Non-electronic portions of an agency data collection policy may also be converted into electronic from for automatic processing by the rules module 214. In some embodiments, the rules module 214 may generate reminder messages that indicate that an agency data collection policy may be potentially out of date after predetermined time intervals. For example, the reminder messages may be email messages, text messages, and/or so forth that are sent to a predesignated contact person at the government agency. The reminder messages may prompt a user of the service record engine 102 to obtain new versions of the agency data collection policy from the government agency.

The rules module 214 may generate an agency data access rule for a government agency based on multiple data access rule sources. The multiple data access rule sources may include federal, state, and/or local laws and regulations regarding individual privacy (e.g., Health Insurance Portability and Accountability Act (HIPAA)), confidential information, government classified data, agency data access policies, and/or so forth. In various embodiments, the rules module 214 may provide an application user interface that enables a user to input data access authorization parameters for different authorized parties based on information from the multiple rule sources. The application user interface that is provided by the rules module 214 may display a set of pre-generated service record data categories, access privilege configuration fields, a pre-populated list of authorized user types, rule customization options, and/or so forth, to facilitate the generation of the jurisdiction data access rule for each government agency.

In instances in which the laws and regulations are in electronic form, the rules module 214 automatically parse the electronic data using a data analysis algorithm, such as a machine learning engine and/or a textual analysis engine. The data analysis algorithm may generate data access authorization parameters for different authorized parties based on the content of the laws and regulations. In some embodiments, the rules module 214 may generate reminder messages to reminder a user to look up for potential updates to each rule or regulation at predetermined time intervals. The reminder messages may prompt a user of the service record engine 102 to obtain new versions of the laws and regulations.

The application user interfaces of the rules module 214 may further present options for configuring overrides to the agency data access rule of a government agency. In various implementation, the configuration may enable data access restrictions on portions of service record data for a government employee to be overridden by one or more particular authorized individuals. The authorized individual may be a supervisor of the government employee, a designated legal representative of the government employee, the government employee in question, and/or so forth. For example, the restriction on the access of medical information in the service record of the government employee may be overridden by the government employee. In another example, the restriction on the access of confidential agency information in the service record of the government employee may be overridden by a supervisor of the government employee.

The authentication module 216 may perform credential management and automate authentication to provide secure access to service record that are stored in the service record engine 102. The authentication module 136 may enable an authorized administrator of the service record engine 102 to create or log into an account in order to oversee and facilitate the creation, retrieval, update, and deletion of agency data collection and data access rules for multiple government agencies. The authorized administrator may be further allowed to trigger the analysis module 220 to generate analytic results, such as the analytic results 132.

The authentication module 216 may further enable authorized end users to create or log into accounts that are used to access the service records data of the government employees. Each authorized end user affiliated with a government agency may be accorded a level of access to the individual service record data of the government agency. The authentication module 216 may provide an authorized end user with selective access to each portion of service record data based on a corresponding permissions table. The authentication module 216 may generate a permission table for each portion of service record data based on a corresponding agency data access rule to control access to the portion of data by different authorized parties. In various embodiments, a permissions table may grant or deny an authorized user access to each portion of service record data based on several factors. The factors may include the identity of the authorized end user, the position of the authorized end user with the government agency, the relationship of the end user with respect to the portion of service record data, and/or so forth. The authentication credentials that are used by a user to authenticate to the authentication module 216 may include one or more of a user name, a password, an electronic identifier, a digital certificate, biometric characteristics, and/or the like.

The reporting module 218 may create data reports for authorized parties based on the queries inputted by the parties. The reporting module 218 may receive input queries and generate data reports for presentation or download via application user interfaces. The input queries for a data report may include one or more specific query parameters for retrieving data that is particular to one or more employees, one or more professional milestones, circumstances, events, injuries, achievements, duty incidents, and/or so forth. In turn, the reporting module 218 may retrieve portions of matching service record data based on the query parameters. Subsequently, the reporting module 218 may selectively include portions of the matching service record data in a data report for presentation based on the access permission of the requesting party for each portion.

In some embodiments, a data report that is generated by the reporting module 218 may include indicators that indicate the reason that a specific portion of information is missing from the data report. In one scenario, a portion of service record information may be missing from a data report because the portion is not collectible under a past version or a current version of a corresponding agency data collection policy. In such a scenario, the application user interface may provide an option for attempting to retrieve the portion of data from one or more third-party sources. For example, if a current credit score of a government employee is not available, the activation of the option may cause the reporting module 218 to attempt to obtain a credit report from a credit reporting agency. Accordingly, the reporting module 218 may either provide the missing portion in the data report or provide an indication that the missing portion is unavailable from the one or more third-party sources, depending on the availability of the data portion from the third-party sources.

In other embodiments, an application use interface of the reporting module 218 may provide an option overriding a corresponding agency data access rule, such that a user is able to view portions of service record data that are otherwise inaccessible to the user. In one scenario, the activation of the option may cause the application user interface to generate an override interface. The override interface may enable another authorized user to input override authentication credentials to access a portion of service record data. The reporting module 218 may send the overriding authentication credentials to the authentication module 216 for validation. Thus, if the authentication module 216 indicates that the authentication credentials belong to a user that is authorized to access the portion of service record data, the reporting module 218 may be commanded by the authentication module 216 to display the otherwise inaccessible portion of service record data on the application user interface. In various embodiments, the reporting module 218 may maintain a log of the overrides for auditing and data security purposes.

The analysis module 220 may generate analysis results, such as the analytic results 132, by analyzing the services record data of government employees. The analysis module 220 may generate analysis results for a specific government employee, for the employees of a government agency, for the employees of multiple government agencies, and/or so forth. The analysis results may be in the form of statistics, trends, or patterns indicating issues affecting the employees. In various embodiments, the analysis module 220 may use machine learning algorithms to detect correlation or causation trends in the careers of the government employees. For example, the analysis may be used to discover common injury patterns, common medical issues, correlation between education level attained to promotion level attained, correlation between number of hours of a shift and injury, and/or so forth.

In some instances, the data analysis may be performed using a combination of service records data and third-party data. The third-party data may include social media data, agency public disclosure data, proprietary data of other service providers, and/or so forth. The analysis module 220 may perform such analysis based on analytical parameters that are inputted at an application user interface. In turn, the analysis module 220 may return the analysis results for presentation or export via the application user interface.

The database module 222 may store the service record data and the rules for collecting and access the service record data into the databases that are in the data store 226. In various embodiments, the databases may be relational databases, object databases, object-relational databases, and/or key-value databases. The record databases 230(1)-230(N) may store service record data for the government agencies, in which each database stores the service record data for a corresponding government agency. Likewise, the rules databases 232(1)-232(N) may store agency data collection and access rules for the government agencies, in which each database stores the rules for a corresponding government agency. For example, the record database 230(1) and the rules database 232(1) may store information for the government agency 110(1). The data store 226 may also store data reports 234 and analytic results 236 that are generated by the reporting module 218 and the analysis module 220.

The data export module 224 may include application program interfaces (APIs) that may be called upon by third-parties to access the data reports 234 and the analytic results 236. In various embodiments, the third-party access to a data report may be provided in compliance with the corresponding agency data access rule, while high level analytic results that obfuscate the individual service record data of government employees may be provided to a third-party without referring to agency data access rules. In some embodiments, the data export module 224 may provide the third-parties with access to the data following authentication by the authentication module 216. Accordingly, the third-parties may register with the authentication module 216 to establish data access accounts.

### Example Processes

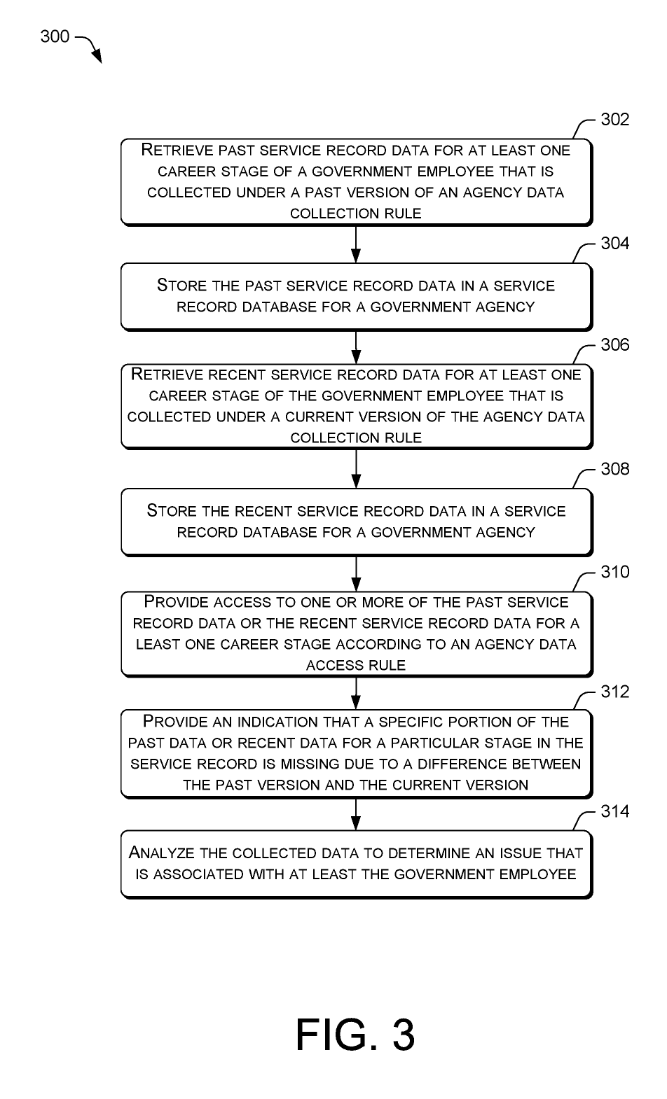

FIGS. 3-7 present illustrative processes 300-700 for using a service record engine to control the collection and access to the service records of government employees. Each of the processes 300-700 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in mirror to implement the process. For discussion purposes, the processes 300-700 are described with reference to the architecture 100 of FIG. 1.

FIG. 3 is a flow diagram of an example process 300 for retrieving service record data for multiple career stages of a government employee, in which the service record data is collected based on multiple versions of an agency data collection rule. At block 302, the service record engine 102 may retrieve past service record data for at least one career stage of a government employee of a government agency that is collected under a past version of an agency data collection rule. The past service record data may be retrieved from one or more data sources that are maintained by the agency. In various embodiments, the agency data collection rule for a government agency may be configured based on the agency data collection polices of the agency. In turn, the agencies data collection policies may be crafted by the agency based on federal, state, and/or local laws and regulations of the jurisdiction in which the government agency resides, best practices of the agency, and/or so forth. At block 304, the service record engine 102 record engine may store the past service record data of the government employee in a service record database of a government agency that employs the government employee.

At block 306, the service record engine 102 may retrieve recent service record data for at least one career stage of the government employee that is collected under a current version of the agency data collection rule. In various embodiments, the current version of the agency data collection rule may differ from the past version in the nature (e.g., type, amount, etc.) of the service record data that is deemed to be collectible. The change in the collectible data may be due a revision of the agency data collection policies. At block 308, the service record engine 102 record engine may store the recent service record data of the government employee in a service record database of a government agency that employs the government employee.

At block 310, the service record engine 102 may provide access to one or more of the past service record data or the recent service record data for at least one career stage according to an agency data access rule. In various embodiments, the agency data access rule may dictate the type and/or nature of the data in the service record of the government employee that can be access by an authorized user. The agency data access rule may be configured by the third-party service provider 106 for the agency based on federal, state, and/or local laws and regulations regarding individual privacy, confidential information, government classified data, and/or so forth. The service record engine 102 may provide access to the service record data in response to a data query from the authorized user following authentication of the authorized user.

At block 312, the service record engine 102 may provide an indication that a specific portion of the past data or the recent data for a particular stage in the service record is missing due to a difference between the past version and the current version of the agency data collection policy. The indication may state the specific reason as to why the missing portion of service record data is unavailable. In some embodiments, the service record engine 102 may generate an application user interface that provides an option for attempting to retrieve the portion of data from one or more third-party sources.

At block 314, the service record engine 102 may analyze the collected data to determine an issue that is associated with at least the government employee. For example, the analysis may be used to discover common injury patterns, common medical issues, correlation between education level attained to promotion level attained, correlation between number of hours of a shift and injury, and/or so forth.

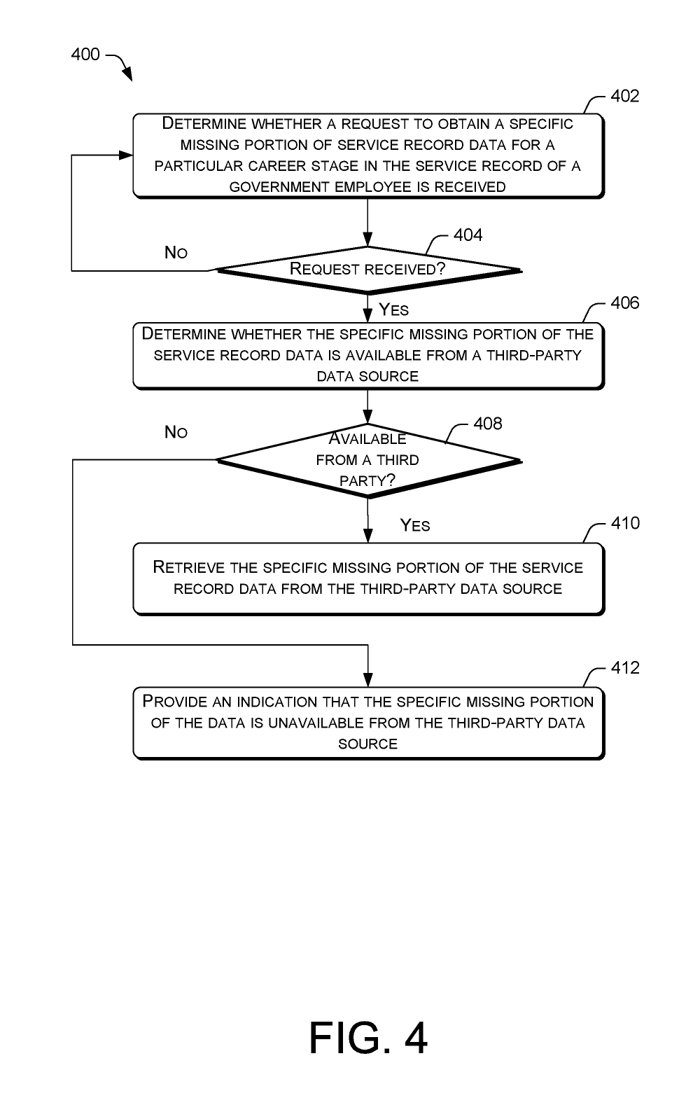

FIG. 4 is a flow diagram of an example process 400 for obtaining a missing data portion in the service record of a government employee from a third-party source. At block 402, the service record engine 102 may determine whether a request to obtain a specific missing portion of service record data for a particular career stage in the service record of a government employee is received. In various embodiments, the service record engine 102 may receive such a request via an application user interface following block 312 of the process 300. At decision block 404, if the service record engine 102 determines that no such request is received, the process 400 may loop back to block 402. However, if the service record engine 102 determines that such a request is received at decision block 404, the process 400 may proceed to block 406.

At block 406, the service record engine 102 may determine whether the specific missing portion is available from a third-party data source. Example of third-party data sources for different career stages may include data sources of credit card reporting agencies, health care facilities, government judicial bodies, and/or so forth. Thus, at decision block 408, if the service record engine 102 determines that the specific missing portion is available from a third-party data source, the service record engine 102 may retrieve the specific missing portion of the service record data from the third-party data source. In some embodiments, the service record engine 102 may obtain the data from the third-party data source by using a data adapter to interface with a database of the third-party data source. In other embodiments, the data from the third-party data source may be received in non-digital form and manually inputted into the service record engine 102 by a user.

Returning to decision block 408, if the service record engine 102 determines that the specific missing portion is not available from the third-party data source, the process 400 may proceed to block 412. At block 412, the service record engine 102 may provide an indication that the specific missing portion of the data is unavailable from the third-party data source.

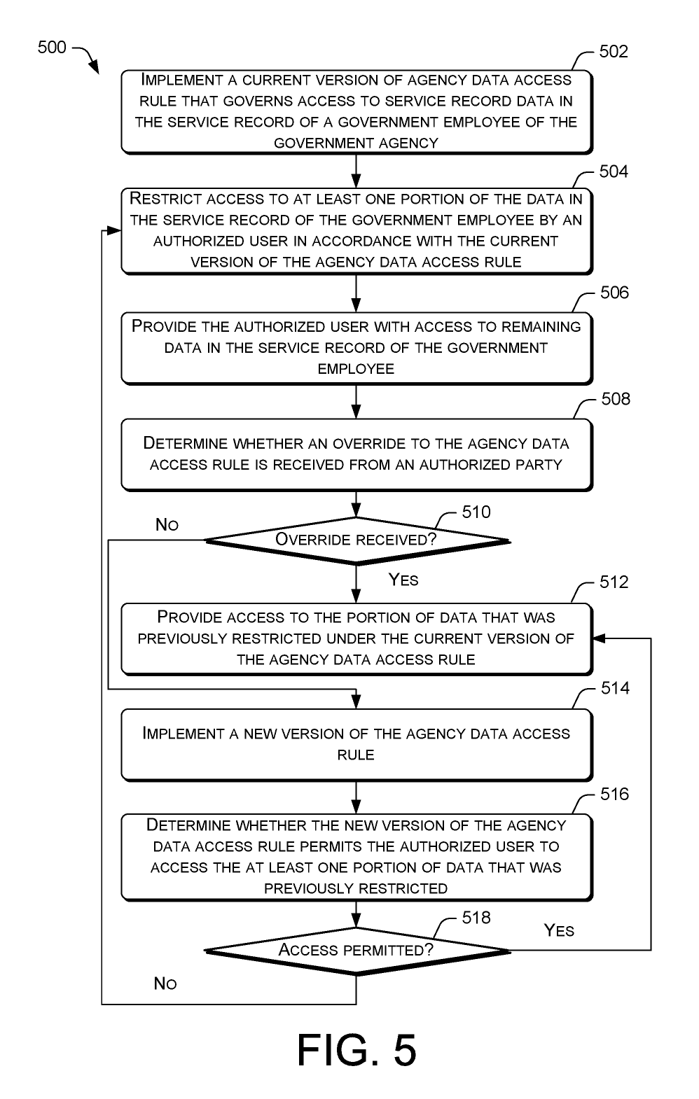

FIG. 5 is a flow diagram of an example process 500 for overcoming an agency data access rule to provide access to a previously inaccessible data portion in the service record of a government employee. The process 500 may further illustrate block 310 of the process 300. At block 502, the service record engine 102 may implement a current version of agency data access rule that governs access to service record data in the service record of a government employee of the government agency. In various embodiments, the agency data access rule may be configured based on federal, state, and/or local laws and regulations regarding individual privacy, confidential information, government classified data, agency policies, and/or so forth.

At block 504, the service record engine 102 may restrict access to at least one portion of the service record data in the service record of the government employee by an authorized user in accordance with the current version of the agency data access rule. In various embodiments, the agency data access rule may restrict or grant access to the at least one portion depending on an identity of the authorized user that is attempting to access the service record data, the position of the authorized user with the government agency, and/or the relationship of the authorized user to the at least one portion of the service record data. At block 506, the service record engine 102 may provide the authorized user with access to remaining data in the service record of the government employee.

At block 508, the service record engine 102 may determine whether an override to the agency data access rule is received from an authorized party. In various embodiments, the authorized party may use an application user interface provided by the service record engine 102 to initiate an override. The authorized party may be a supervisor of the government employee, a designated legal representative of the government employee, the government employee in question, and/or so forth. Thus, if the service record engine 102 determines at decision block 510 that an override is received, the process 500 may proceed to block 512. At block 512, the service record engine 102 may provide access to the portion of the data was previously restricted under the current version of the agency data access rule.

However, if the service record engine 102 determines at decision block 510 that an override is not received, the process 500 may proceed to block 514. At block 514, the service record engine 102 may implement a new version of the agency data access rule. In various embodiments, the new version of the agency data access rule may delete, modify, or add data access restrictions on service record data access by different authorized users based on changes to applicable laws and regulations of a jurisdiction that govern the agency.

At block 516, the service record engine 102 may determine whether the new version of the agency data access rule permits the authorized user to access the at least one portion of the data that was previously restricted. Thus, if the service record engine 102 determines that the new version of the agency data access rule permits the authorized user to access the at least one restricted data portion (“yes” at decision block 518), the process 500 may loop back to block 512. However, if the service record engine 102 determines that the new version of the agency data access rule does not permit the authorized user to access the at least one restricted data portion (“yes” at decision block 518), the process 500 may loop back to block 504.

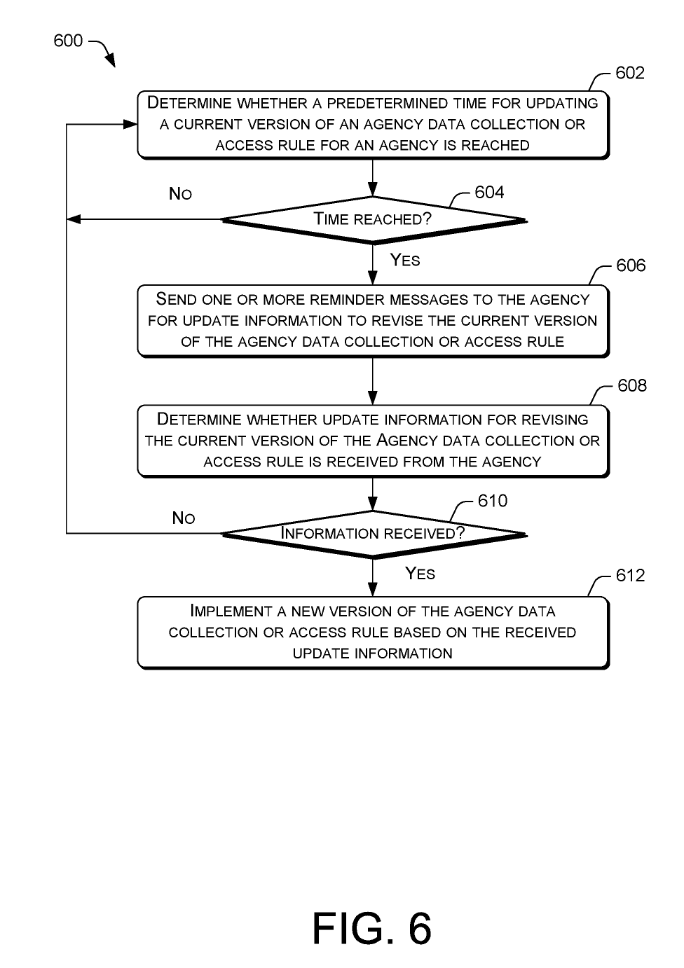

FIG. 6 is a flow diagram of an example process 600 for periodically updating an agency rule that governs data collection or data access with respect to the service records of government employees. At block 602, the service record engine 102 may determine whether a predetermined time for updating a current version of an agency data collection or data access rule for an agency is reached. Thus, at decision block 604, if the service record engine 102 determines that the predetermined time is not reached, the process 600 may loop back to block 602. However, if the service record engine 102 determines that the predetermined time is reached (“yes” at decision block 604), the process 600 may proceed to block 606.

At block 606, the service record engine 102 may send one or more reminder messages to the agency for update information to revise the current version of the agency data collection or access rule. In various embodiments, the reminder messages may be email messages, text messages, and/or so forth that are sent to a predesignated contact person at the government agency.

At block 608, the service record engine 102 may determine whether update information for revising the current version of the agency data collection or access rule is received from the government agency. Thus, at decision block 610, if the service record engine 102 determines that the update information is received (“yes” at decision block 610), the process 600 may proceed to block 612. At block 612, the service record engine 102 may implement a new version of the agency data collection or access rule based on the received update information. However, if the service record engine 102 determines that no update information is received (“no” at decision block 610), the process 600 may loop back to block 602.

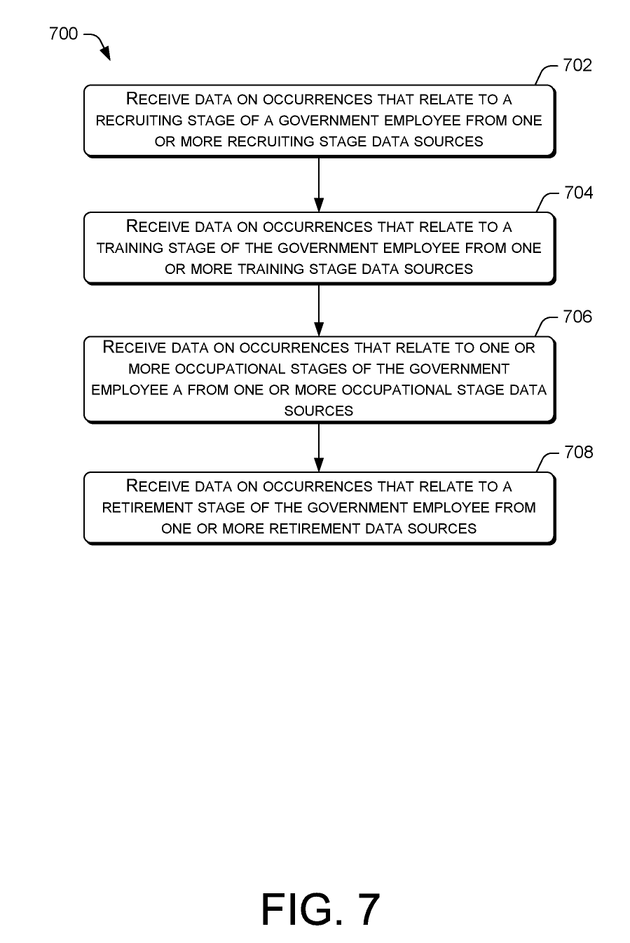

FIG. 7 is a flow diagram of an example process 700 for receiving data regarding the service record of a government employee from multiple data sources. The process 700 may further illustrate the block 302 or the block 306 of the process 300. At block 702, the service record engine 102 may receive data on occurrences that relate to a recruiting stage of a government employee from one or more recruiting stage data sources. In various embodiments, the recruiting stage data sources may provide data such as personal identification information, demographic information, educational attainment information, background check information, aptitude test score information, and/or so forth for a government employee.

At block 704, the service record engine 102 may receive data on occurrences that relate to a training stage of the government employee from one or more training stage data sources. In various embodiments, the training stage data sources may provide data on the status of the government employee in completing related training or certification programs. The successful completion of a certification or training program by a government employee may indicate that the employee has attained basic proficiency in performing the related duties.

At block 706, the service record engine 102 may receive data on occurrences that relate to one or more occupational stages of the government employee from one or more occupational stage data sources. In various embodiments, the occupational stage data sources may provide data on the service history and achievements of a government employee. In various embodiments, the service history information of the government employees may be divided and stored in different data sources based on the seniority levels achieved by the employee.

At block 708, the service record engine 102 may receive data on occurrences that relate to a retirement stage of the government employee from one or more retirement stage data sources. In various embodiments, the retirement stage data sources may provide post-career data on a government employee. The post-career data may include pension plan status, medical benefit status, health condition status, and/or other data that measure the effect of a career in government has on the life of the government employee.

A third-party operated service record engine may provide government agencies with a centralized location to retain the service records of their government employees without having to invest in and maintain their own information technology infrastructure. The service record engine may also provide the government agencies or the operator of the service record engine with the ability to analyze the service records to ascertain systematic problems and trends that may affect the careers of their government employees. Accordingly, the use of the service record engine by government agencies may result in reduced operating cost and greater convenience for the agencies.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more computer-readable media of a mobile telecommunication network storing computer-executable instructions that upon execution cause one or more processors to perform acts comprising:
retrieving service record data for individual career stages of a government employee of a government agency from individual corresponding data sources of the government agency for storage at a third-party service provider, the service record data being collected under an agency data collection rule specific to the government agency, the individual career stages including at least one of a recruiting stage, a training stage, one or more occupational stages, or a retirement stage;
storing the service record data for the individual career stages of the government employee in a service record database maintained by the third-party service provider for the government agency; and
providing access to at least one portion of the service record data for one or more career stages of the government employee to an authorized user according to an agency data access rule, the agency data access rule being configured for the government agency by the third-party service provider based at least on laws and regulations of a jurisdiction in which the government agency resides.

2. The one or more computer-readable media of claim 1, wherein the acts further comprise analyzing the service record data with at least one of additional service record data of one or more other government employees of the government agency or third-party data to generate statistics, trends, or patterns indicating an issue that affects one or more government employees.

3. The one or more computer-readable media of claim 1, wherein the retrieving the service record data includes:
retrieving past service record data for at least one career stage of the government employee that is collected under a past version of the agency collection rule;
retrieving recent service record data for at least one career stage of the government employee that is collected under a current version of the agency collection rule, and wherein the acts further comprise providing an indication that a specific service record portion of the past service record or the recent service record data for a particular career stage is missing due to a difference between the past version and the current version of the agency collection rule.

4. The one or more computer-readable media of claim 3, wherein the acts further comprise:
receiving a request to obtain the specific service record portion that is missing from the particular career stage from a third-party data source;
retrieving the specific service record portion that is missing from the third-party data source in response to a determination that the specific service record portion is available from the third-party data source; and
providing an indication that the specific service record portion is unavailable in response to a determination that the specific service record portion is unavailable from the third-party data source.

5. The one or more computer-readable media of claim 1, wherein the providing access to at least one portion of the service record data includes:
restricting access by the authorized user to one or more portions of the service record data in a career stage of the government employee based on at least one of an identity of the authorized user, a position of the authorized user, or a relationship of the authorized user to the one or more portions of the service record data; and
providing the authorized user with access to remaining portion of the service record data in the career stage of the government employee.

6. The one or more computer-readable media of claim 5, wherein the providing access to at least one portion of the service record data further includes:
receiving an override to the agency data access rule from an authorized party for the authorized user to access the one or more portions of the service record data in the career stage of the government employee; and
providing the authorized user with access to the one or more portions of the service record data in the career stage of the government employee following the override.

7. The one or more computer-readable media of claim 6, wherein the authorized party is a supervisor of the government employee, a designated legal representative of the government employee, or the government employee.

8. The one or more computer-readable media of claim 5, wherein the providing access to at least one portion of the service record data further includes:
implementing a new version of the agency data access rule that permits the authorized user to access the one or more portions of the service record data in the career stage of the government employee; and
providing the authorized user with access to the one or more portions of the service record data in the career stage of the government employee following implementation of the new version.

9. The one or more computer-readable media of claim 1, wherein the acts further comprise:
sending one or more reminder messages to the government agency for update information to revised the agency data collection rule or the agency data access rule;
implementing a new version of the agency data collection rule or the agency data access rule based on the update information received from the government agency.

10. The one or more computer-readable media of claim 1, wherein the authorized user is the government employee, a supervisor of the government employee, a manager of the government agency, or an auditor of the government agency, or a third-party authorized user.

11. A computer-implemented method, comprising:
receiving, via one or more computing nodes, past service record data for at least one career stage of a government employee of a government agency from one or more corresponding data sources of the government agency for storage at a third-party service provider, the service record data being collected under a past version of an agency data collection rule specific to the government agency;
receiving via the one or more computing nodes, recent service record data for the at least one career stage of the government employee from the one or more corresponding data sources of the government agency for storage at the third-party service provider, the recent service record data being collected under a current version of the agency data collection rule specific to the government agency;
storing, via the one or more computing nodes, the past service record data and the recent service record data in a service record database maintained by the third-party service provider for the government agency;
providing, via the one or more computing nodes, access to at least one portion of the service record data for one or more career stages of the government employee to an authorized user according to an agency data access rule, the agency data access rule being configured for the government agency by the third-party service provider based at least on laws and regulations of a jurisdiction in which the government agency resides; and
providing, the one or more computing nodes, an indication that a specific service record portion of the past service record data or the recent service record data for a particular career stage is missing due a difference between the past version and the current version of the agency data collection rule.

12. The computer-implemented method of claim 11, further comprising:
receiving a request to obtain the specific service record portion of the past service record data or the recent service record data from a third-party data source;
retrieving the specific service record portion from the third-party data source in response to a determination that the specific service record portion is available from the third-party data source; and
providing an indication that the specific service record portion is unavailable in response to a determination that the specific service record portion is unavailable from the third-party data source.

13. The computer-implemented method of claim 11, wherein the one or more data sources includes a recruiting career stage database, a training career stage database, one or more occupational career stage databases, and a retirement stage database that are maintained by the government agency, and wherein at least one of the data sources is maintained by a third-party.

14. The computer-implemented method of claim 13, wherein the recruiting career stage database provides at least one of personal identification information, demographic information, educational attainment information, background check information, or aptitude test score information of the government employee, the training career stage database stores provides data on a status of the government employee in completing a training program or a certification program, the occupational career stage databases provide data on a service history and achievements of the government employee, and the retirement stage database provides post-career data that measure an effect of a career in government has on a quality of life of the government employee.

15. The computer-implemented method of claim 11, wherein the providing access to at least one portion of the service record data includes:
restricting access by the authorized user to one or more portions of the service record data in a career stage of the government employee based on at least one of an identity of the authorized user, a position of the authorized user, or a relationship of the authorized user to the one or more portions of the service record data; and
providing the authorized user with access to remaining portion of the service record data in the career stage of the government employee.

16. The computer-implemented method of claim 15, wherein the providing access to at least one portion of the service record data further includes:
receiving an override to the agency data access rule from an authorized party for the authorized user to access the one or more portions of the service record data in the career stage of the government employee; and
providing the authorized user with access to the one or more portions of the service record data in the career stage of the government employee following the override.

17. The computer-implemented method of claim 16, wherein the authorized party is a supervisor of the government employee, a designated legal representative of the government employee, or the government employee.

18. The computer-implemented method of claim 15, wherein the providing access to at least one portion of the service record data further includes:
implementing a new version of the agency data access rule that permits the authorized user to access the one or more portions of the service record data in the career stage of the government employee; and
providing the authorized user with access to the one or more portions of the service record data in the career stage of the government employee following implementation of the new version.

19. One or more computing nodes, comprising:
one or more processors; and
memory having instructions stored therein, the instructions, when executed by the one or more processors, cause the one or more processors to perform acts comprising:
retrieving, via one or more computing nodes, past service record data for at least one career stage of a government employee of a government agency from one or more corresponding data sources of the government agency for storage at a third-party service provider, the service record data being collected under a past version of an agency data collection rule specific to the government agency;
retrieving, via the one or more computing nodes, recent service record data for the at least one career stage of the government employee from the one or more corresponding data sources of the government agency for storage at the third-party service provider, the recent service record data being collected under a current version of the agency data collection rule specific to the government agency;
storing, via the one or more computing nodes, the past service record data and the recent service record data in a service record database maintained by the third-party service provider for the government agency;
restricting access by an authorized user to one or more portions of the service record data in a career stage of the government employee according to an agency data access rule, the agency data access rule being configured for the government agency by the third-party service provider based at least on laws and regulations of a jurisdiction in which the government agency resides; and
providing the authorized user with access to remaining portion of the service record data in the career stage of the government employee.

20. The one or more computing nodes of claim 19, wherein the acts further comprise providing an indication that a specific service record portion of the past service record data or the recent service record data for a particular career stage is missing due a difference between the past version and the current version of the agency data collection rule.
